(19) United States
(12) Patent Application Publication
(10) Pub. No.: US 2009/0309310 A1
(43) Pub. Date: Dec. 17, 2009

(54) Blender Blade Sealing System

(76) Inventor: Ian Geoffrey Wilson, New South Wales (AU)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/295,423

(22) PCT Filed: Mar. 29, 2007
(86) PCT No.: PCT/AU2007/000388

§ 371 Date: Mar. 27, 2009

(30) Foreign Application Priority Data
Mar. 31, 2006 (AU) 2006901668

(51) Int. Cl. F16J 15/02

(52) U.S. Cl. 277/312; 277/637

(57) ABSTRACT

A sealing system for a food blending appliance; said sealing system providing a seal between a blade assembly and an open base of a jug of said appliance; said seal comprising a first upper sealing element and a seal-retaining element; wherein said first upper sealing element provides a substantially smooth transition between internal surfaces of said jug and an upper surface of said blade assembly.

The present invention relates to food blenders and, more particularly, to food blenders intended for domestic kitchen use.

### BACKGROUND

Food blenders have become a popular appliances both for domestic and commercial use in the preparation of a wide variety of food ingredients. Blenders typically include a base which incorporates the motor and controls, a blade assembly and a jug.

The cutting blade or blades are arranged with a vertical axis at the bottom of the jug and are usually directly driven from the motor at speeds in excess of 10,000 rpm, the high speed rapidly cutting food and even solid material such as ice into very fine particles.

By having the blades situated at the bottom of the jug, food particles are repeatedly thrown outwards and upwards to fall back down to be recycled through the blades.

It is clearly essential from a health point of view that the blades be accessible for cleaning. Again typically, in the case of domestic blender appliances this is achieved as shown in FIG. 1, by the jug having an open bottom which is releasably attached to the blade assembly and base, so that removal of the jug gives access to the blades without actually having to touch the sharp edges of the blades.

This contrasts with the typical arrangement of commercial blenders shown in FIG. 2, in which the sides and base of the jug form a continuous whole and from which the blades are extracted from inside the jug for cleaning. This arrangement allows a larger diameter of blades relative to the sides of the jug and a smooth continuous transition between the blade supporting base and the sides of the jug. This arrangement makes it difficult for the blended material to “hang” on the walls and avoid being recirculated through the blades.

The arrangement of the typical domestic blender is preferred for the convenient and safer means of access to the blades but comes with associated problems of effective sealing between the jug rim and loss of mixing efficiency because of the difficulty of providing a smooth transition between the blade supporting base and the sides of the jug.

This latter is due to the inherent design limitations of the glass jugs preferred for domestic blenders. It is necessary (from a manufacturing point of view), to have the parting line for the jug core across the bottom of the jug. The parting line always leaves a jagged edge and must be machined off thereby providing a flat surface for sealing. However, for a jug with a square or hexagonal shaped upper section, this surface can only be provided at the base of a cylindrical wall portion which carries the external thread for attaching the jug to the blade supporting base. Even for a round upper section jug, a lower cylindrical wall portion at a smaller diameter to carry the securing thread is essential to avoid securing ring projecting outside of the jug profile.

Again, the manufacturing process dictates that the internal surface of this cylindrical wall portion has a draft so that the surface is in effect a portion of an inverted cone. To then provide a blade supporting base for a smooth form of the jug would leave a gap between the jug and base as can be seen in FIG. 3. Such a gap will collect food particles and unless cleaned after every use, becomes a potential health problem.

It is an object of the present invention to address or at least ameliorate some of the above disadvantages.

### Note

The term “comprising” (and grammatical variations thereof) is used in this specification in the inclusive sense of “having” or “including”, and not in the exclusive sense of “consisting only of”.

### BRIEF DESCRIPTION OF INVENTION

Accordingly, there is provided in a first broad form of the invention a sealing system for a food blending appliance; said sealing system providing a seal between a blade assembly and an open base of a jug of said appliance; said seal comprising a first upper sealing element and a seal-retaining element; wherein said first upper sealing element provides a substantially smooth transition between internal surfaces of said jug and an upper surface of said blade assembly.

Preferably, said seal-retaining element comprises a semi-rigid collar; said collar comprising a cylindrical portion provided with an outwardly extending flange at a lower edge of said cylindrical portion.

Preferably, said first upper sealing element at least partially envelops an upper edge of said semi-rigid collar.

Preferably, said outwardly extending flange of said semi-rigid collar is retained between a planar annular surface at an underside of said jug and an upper surface of an annular flange of said blade assembly.

Preferably, said system includes a second lower sealing element; said second lower sealing element at least partially enveloping said outwardly extending flange of said semi-rigid collar.

Preferably, said second lower sealing element provides a seal between said planar annular surface at said underside of said jug and an said upper surface of said annular flange of said blade assembly.

Preferably, said first upper sealing element provides a seal between an internal annular surface of said jug and an outer annular surface of said blade assembly.

Preferably, said second lower sealing element and said first upper sealing element comprise elastomer rings, said elastomer rings joined by said semi-rigid collar.

Preferably, said blade assembly includes a blade supporting base member; said blade supporting base member comprising a circular base portion and a peripheral skirt depending substantially vertically from said circular base portion; an outer surface of said skirt defining said outer annular surface.

Preferably, said annular flange of said blade assembly extends outwardly from a lower edge of said peripheral skirt.

Preferably, said jug is open at said underside; a base portion of said jug forming a cylindrical wall at said underside; an internal surface of said cylindrical wall defining said internal annular surface of said jug; an underside of said cylindrical wall defining said planar annular surface.

Preferably, the diameter of an internal lower edge of said cylindrical wall is larger than the outer diameter of said peripheral skirt; respective diameters differing by an amount adapted to leave a gap between said internal lower edge and said skirt sufficient for the thickness of a said cylindrical portion of said collar.

Preferably, said second lower sealing element is held in compression between said planar annular surface and said annular flange of said blade assembly.

Preferably, said internal annular surface forms a portion of an inverted cone between said internal lower edge and an internal upper edge of said internal annular surface, such that a gap between said internal upper edge and said skirt is larger than said gap between said internal lower edge and said skirt.

Preferably, said first upper sealing element is held in compression between said internal upper edge and said skirt.

Preferably, said circular base portion of said blade assembly, an upper outer surface of said first upper sealing element and internal surfaces of said jug are arranged to form a continuous substantially smooth surface extending from a vertical drive shaft of blades of said food blending appliance to upper edges of said jug.

Preferably, an outer surface of said cylindrical wall at said underside of said jug is provided with thread formations; said thread formations adapted to engage with thread formations of a securing ring; said securing ring adapted to connect said blade supporting base member to said jug; said securing ring provided with an inwardly extending flange adapted to apply said compression of said second lower sealing element.

Preferably, said first upper sealing element is substantially of triangular cross section; said elastomer material of said upper sealing element overmoulded over said upper edge of said semi-rigid collar.

Preferably, said second lower sealing element is substantially of rectangular cross section; said elastomer material of said lower sealing element overmoulded over said outwardly extending flange of said semirigid collar.

In a further broad form of the invention, there is provided a seal for the junction between the blade assembly of a food blending appliance and a jug of said appliance; said seal including a first upper sealing element and a second lower sealing element; said first upper sealing element and said second lower sealing element joined by a collar.

In yet another broad form of the invention, there is provided a method of providing a smooth transition between an upper surface of a blade assembly of a food blending appliance and internal surfaces of an open base jug of said appliance; said method including the step of providing a dual seal sealing system between said blade assembly and an open base of said jug.

Preferably, said dual seal includes an elastomer first upper sealing element and an elastomer second lower sealing element.

Preferably, said first upper sealing element and said second lower sealing element are joined by a semi-rigid collar.

Preferably, said first upper sealing element provides a seal for a gap formed between a skirt of said blade assembly and an outwardly tapering internal surface of said jug.

Preferably, said second lower sealing element provides a seal between a planar annular surface at an underside of said open base jug and an outwardly projecting flange of said blade assembly.

### BRIEF DESCRIPTION OF DRAWINGS

Embodiments of the present invention will now be described with reference to the accompanying drawings wherein:

FIG. 1, is a cross section of the upper portion of a typical blade assembly and jug of a domestic kitchen food blender according to the prior art,

FIG. 2, is a cross section of a typical blade assembly and jug of a commercial food blender according to the prior art,

FIG. 3, is a cross section of an upper portion of a blade assembly and a glass jug configured according to a preferred embodiment of the invention,

FIG. 4, is a cross section of the blade assembly and glass jug of FIG. 3 with a preferred embodiment of a sealing system according to the invention installed,

FIG. 5, is a detailed view of the installed sealing system of FIG. 4.

### DETAILED DESCRIPTION OF PREFERRED EMBODIMENTS

### First Preferred Embodiment

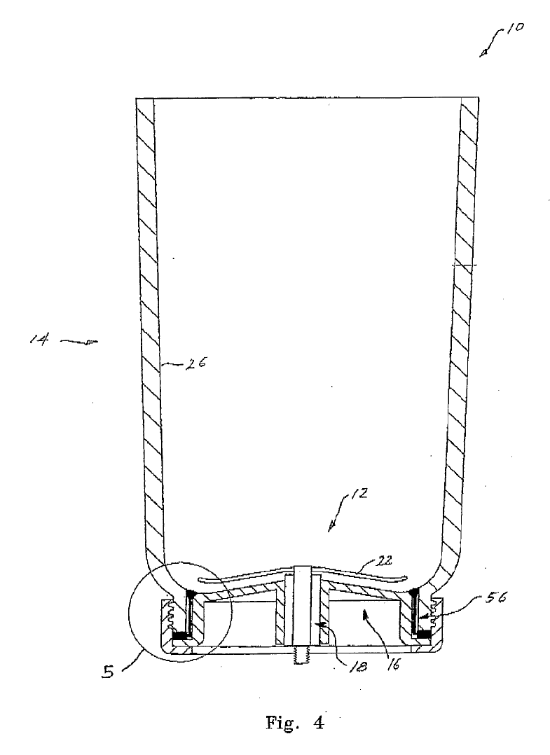

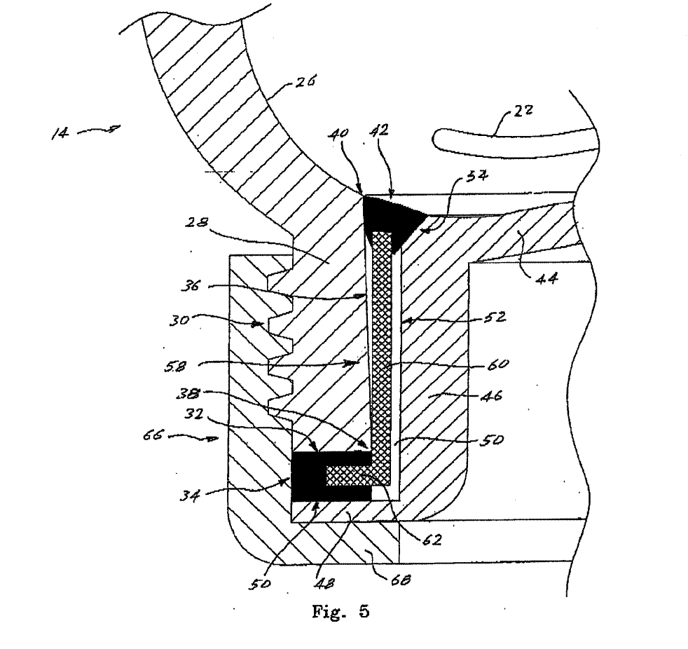

With reference to FIGS. 4 and 5, a food blending appliance 10 intended primarily, though not exclusively, for domestic kitchen use, includes a blade assembly 12 and glass jug 14. Blade assembly 12 includes a blade supporting base member 16 provided with a central bearing and conventional seal assembly 18 for support of a vertical drive shaft 20 and blades 22. Vertical drive shaft 20 and blades 22 are urged into rotational movement by a conventional drive motor mounted in a base enclosure (not shown).

Glass jug 14 is of typical and conventional construction, comprising a base region 24 open at the underside, from which rise outwardly sloping side walls 26. Side walls 26 may be of circular or square cross section, but base region 24 comprises a cylindrical wall 28 provided with an external thread formation 30. The underside of cylindrical wall 28 is machined flat (as explained above) to provide a planar annular surface 32 and, in this first preferred embodiment, forms a first sealing surface for a second lower sealing element 34.

As also explained above, the internal annular surface 36 of cylindrical wall 28 is provided with a draft for manufacturing purposes-. Thus the internal annular surface 36 in effect is a portion of an inverted conical surface between two parallel planes, the respective planes defining an internal lower edge 38 and an internal upper edge 40. An annular region of the internal surface immediately below the internal upper edge 40 forms a first sealing surface for a first upper sealing element 42.

Blade supporting base member 16 comprises a circular base portion 44 and a peripheral skirt 46 depending vertically from the periphery of base portion 44. Peripheral skirt 46 is provided with an outwardly extending annular flange 48 the upper surface 50 of which forms a second sealing surface for the second lower sealing element 34.

The outer diameter of peripheral skirt 46 is such that a gap 50 is left between the outer annular surface 52 of skirt 46 and the internal lower edge 38 of cylindrical wall 28. Because of the conical geometry of the internal annular surface 36 of cylindrical wall 28, the gap 50 between the outer surface of skirt 46 and the internal upper edge 40 of internal annular surface 36 is larger than that between the skirt and the internal lower edge 38 (as can best be seen in FIG. 3). The peripheral edge of circular base portion 44 is provided with a chamfer 54, forming a second sealing surface for the first upper sealing element 42.

The seal 56 of the present invention comprises the first upper sealing element 42 and second lower sealing element 34, preferably linked together by a semi-rigid collar 58. Preferably collar 58 has a cross sectional configuration in the shape of an “L”, comprising a cylindrical portion 60 and an outwardly extending flange 62 from the lower edge of cylindrical portion 60. The semi-rigid collar 58 acts to prevent the first upper seal 42 from being drawn down into the tapering gap 50 when blade assembly 12 is extracted from jug 14, causing jamming and preventing a smooth separation of jug and blade assembly.

The second lower sealing element 34 comprises a rectangular cross section moulding, overmoulded over outwardly extending flange 62, while the first upper sealing element 42 comprises a generally triangular cross section moulding, overmoulded over the upper edge of cylindrical portion 60 of collar 58. Both sealing elements are moulded in a food grade elastomer. Preferably, the material of collar 28 is of a semi-rigid plastic such as for example a polypropylene.

As shown in FIG. 5, second lower sealing element 34 is adapted for sealing compression between the planar annular surface 32 of cylindrical wall 28 and the upper surface 64 of outwardly extending flange 48. Compression is provided in a conventional manner by an internally threaded securing ring 66, provided with an inwardly extending flange 68. First upper sealing element 42 is adapted to seal the gap between the chamfer 54 of circular base portion 44 and the surface below internal upper edge 40 of cylindrical wall 28, thereby preventing the ingress of food material into the gap between peripheral skirt 46 and internal annular surface 36.

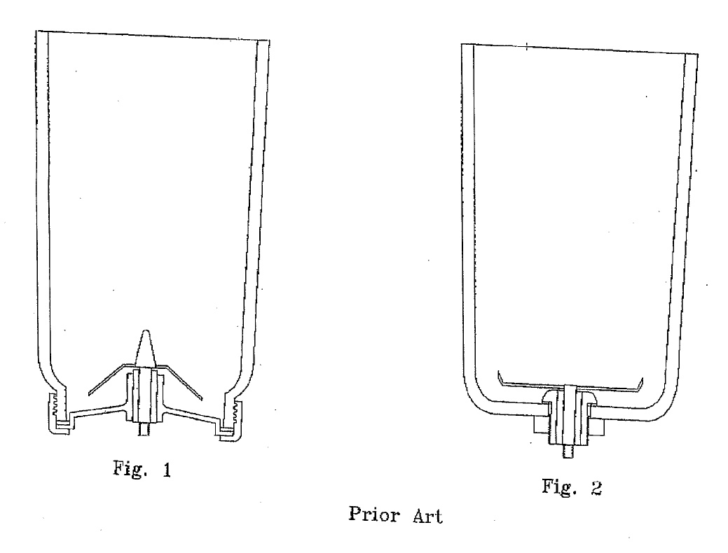

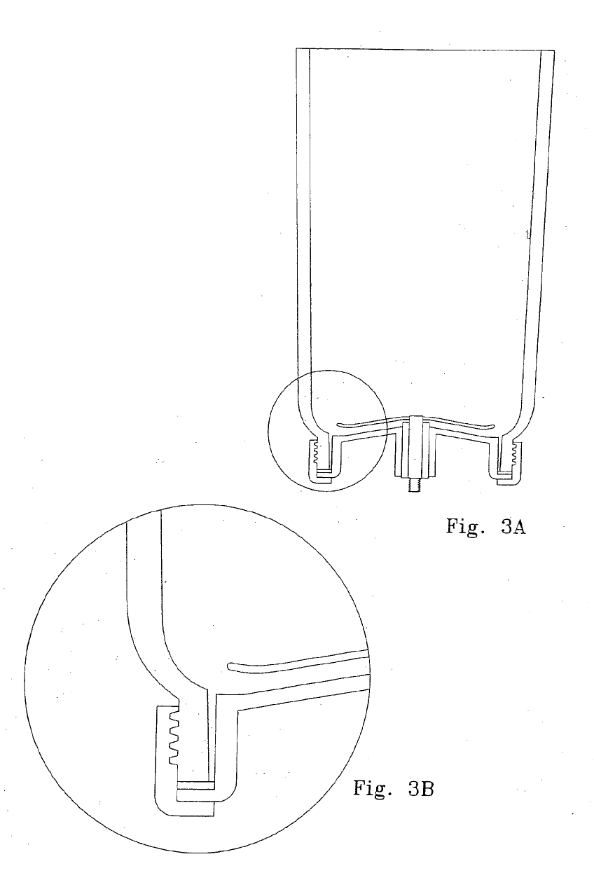

The arrangement of the dual sealing elements 34 and 42 of the present invention allows for a virtually smooth continuation of the surface of the blade supporting base member 16 and the internal surfaces of the jug 14. This virtually smooth internal surface formed by the assembled jug and blade assembly contrasts strongly with the arrangement of conventional blenders shown in FIG. 1, ensuring that material flung outwardly by the blades flows efficiently upwards along the walls of the jug, reducing undesirable pooling of the material. The sealing system of the present invention thus combines the features of convenient access to the blades for cleaning and the greater efficiency of blending usually only found in commercial blenders.

### Second Preferred Embodiment

This preferred embodiment is identical to the first embodiment described above except that in this case the sealing system is simplified to comprise of the semi-rigid collar with first upper sealing element only. The semi-rigid collar is again provided with an outwardly extending flange as described above, but does not have an overmoulded elastomer sealing element, so that in this embodiment, the semi-rigid collar forms a seal-retaining element. The outwardly extending flange on assembly of the jug to the blade assembly is locked between the underside of the jug and the surface of the securing ring, thereby securing the upper sealing element in its correct sealing position between the inside surface of the jug and the peripheral skirt of the blade assembly.

The above describes only some embodiments of the present invention and modifications, obvious to those skilled in the art, can be made thereto without departing from the scope and spirit of the present invention.

1. A sealing system for a food blending appliance; said sealing system providing a seal between a blade assembly and an open base of a jug of said appliance; said seal comprising a first upper sealing element and a seal-retaining element; wherein said first upper sealing element provides a substantially smooth transition between internal surfaces of said jug and an upper surface of said blade assembly.

2. The system of claim 1 wherein said seal-retaining element comprises a semi-rigid collar; said collar comprising a cylindrical portion provided with an outwardly extending flange at a lower edge of said cylindrical portion.

3. The system of claim 2 wherein said first upper sealing element at least partially envelops an upper edge of said semi-rigid collar.

4. The system of claim 2 wherein said outwardly extending flange of said semi-rigid collar is retained between a planar annular surface at an underside of said jug and an upper surface of an annular flange of said blade assembly.

5. The system of any one of claim 2 wherein said system includes a second lower sealing element; said second lower sealing element at least partially enveloping said outwardly extending flange of said semi-rigid collar.

6. The system of claim 5 wherein said second lower sealing element provides a seal between said planar annular surface at said underside of said jug and an said upper surface of said annular flange of said blade assembly.

7. The system of claim 1 wherein said first upper sealing element provides a seal between an internal annular surface of said jug and an outer annular surface of said blade assembly.

8. The system of any one of claim 5 wherein said second lower sealing element and said first upper sealing element comprise elastomer rings; said elastomer rings joined by said semi-rigid collar.

9. The system of claim 7 wherein said blade assembly includes a blade supporting base member; said blade supporting base member comprising a circular base portion and a peripheral skirt depending substantially vertically from said circular base portion; an outer surface of said skirt defining said outer annular surface.

10. The system of claim 9 wherein said annular flange of said blade assembly extends outwardly from a lower edge of said peripheral skirt.

11. The system of claim 7 wherein said jug is open at said underside; a base portion of said jug forming a cylindrical wall at said underside; an internal surface of said cylindrical wall defining said internal annular surface of said jug; an underside of said cylindrical wall defining said planar annular surface.

12. The system of claim 11 wherein the diameter of an internal lower edge of said cylindrical wall is larger than the outer diameter of said peripheral skirt; respective diameters differing by an amount adapted to leave a gap between said internal lower edge and said skirt sufficient for the thickness of a said cylindrical portion of said collar.

13. The system of claim 5 wherein said second lower sealing element is held in compression between said planar annular surface and said annular flange of said blade assembly.

14. The system of claim 12 wherein said internal annular surface forms a portion of an inverted cone between said internal lower edge and an internal upper edge of said internal annular surface, such that a gap between said internal upper edge and said skirt is larger than said gap between said internal lower edge and said skirt.

15. The system of claim 14 wherein said first upper sealing element is held in compression between said internal upper edge and said skirt.

16. The system of claim 9 wherein said circular base portion of said blade assembly, an upper outer surface of said first upper sealing element and internal surfaces of said jug are arranged to form a continuous substantially smooth surface extending from a vertical drive shaft of blades of said food blending appliance to upper edges of said jug.

17. The system of any one of claim 11 wherein an outer surface of said cylindrical wall at said underside of said jug is provided with thread formations; said thread formations adapted to engage with thread formations of a securing ring; said securing ring adapted to connect said blade supporting base member to said jug; said securing ring provided with an inwardly extending flange adapted to apply said compression of said second lower sealing element.

18. The system of claim 3 wherein said first upper sealing element is substantially of triangular cross section; said elastomer material of said upper sealing element overmoulded over said upper edge of said semi-rigid collar.

19. The system of claim 5 wherein said second lower sealing element is substantially of rectangular cross section; said elastomer material of said lower sealing element overmoulded over said outwardly extending flange of said semi-rigid collar.

20. A seal for the junction between the blade assembly of a food blending appliance and a jug of said appliance; said seal including a first upper sealing element and a second lower sealing element; said first upper sealing element and said second lower sealing element joined by a collar.

21. A method of providing a smooth transition between an upper surface of a blade assembly of a food blending appliance and internal surfaces of an open base jug of said appliance; said method including the step of providing a dual seal sealing system between said blade assembly and an open base of said jug.

22. The method of claim 21 wherein said dual seal includes an elastomer first upper sealing element and an elastomer second lower sealing element.

23. The method of claim 22 wherein said first upper sealing element and said second lower sealing element are joined by a semi-rigid collar.

24. The method of claim 22 wherein said first upper sealing element provides a seal for a gap formed between a skirt of said blade assembly and an outwardly tapering internal surface of said jug.

25. The method of claim 22 wherein said second lower sealing element provides a seal between a planar annular surface at an underside of said open base jug and an outwardly projecting flange of said blade assembly.

26. (canceled)
